(19) United States
(12) Patent Application Publication
(10) Pub. No.: US 2008/0077062 A1
(43) Pub. Date: Mar. 27, 2008

(54) REMOVABLY MOUNTED MASSAGER

(76) Inventors: Harry Leiter, Palm Desert, CA (US); Symme Leiter, Palm Desert, CA (US)

Correspondence Address: MILORD & ASSOCIATES, P.C., 10880 WILSHIRE BOULEVARD, SUITE 2070, LOS ANGELES, CA, 90024, US

(21) Appl. No.: 11/535,641

(22) Filed: Sep. 27, 2006

(51) Int. Cl. A61H 7/00

(52) U.S. Cl. 601/134; 601/84

(57) ABSTRACT

A removably mounted massager device that is capable of attaching to objects of varying sizes in a secure, yet easily disengaging, manner. A protrusion is located on the massager device in a removable manner such that variously shaped protrusions may be attached thereto. An adjustable attaching member allows engagement of the massager device to objects of varying size.

### FIELD OF THE INVENTION

The invention relates to skin stimulators in general and, more particularly, to the art of a massager that can easily be securely mounted to a portion of a door to allow manipulation of a back of a user, yet is removable, adjustable and transportable.

### BACKGROUND OF THE INVENTION

Numerous massagers are known in the art, the most common of which are the hand held massagers for massaging a person's back. However, hand held massagers do not allow a sufficient application of force to be applied to the back of a user because the body must be contorted in order to reach the back. Numerous attempts have been made to provide substitutes for the hand held massagers.

For instance, U.S. Pat. No. 5,833,635 to Aboud discloses a massager having a mounting bracket that permits the stimulator to be mounted onto a wall, a door, or a floor stand.

U.S. Pat. No. 5,174,282 to Bleggi discloses a massager that is suspended from a door frame by a resilient cord.

U.S. Pat. No. 4,733,842 to Wilkerson discloses a complex mounting structure for mounting a massager onto a door frame.

U.S. Pat. No. 2,347,327 to London discloses a mounting structure that fixes a massager to a door.

U.S. Patent Application No. 20020133104 to Bedgood discloses a massager that can be mounted onto a flat surface of a door or a wall by means of an adhesive. The adhesive may be detrimental to the surface to which the massager is affixed.

The prior art does not address the need for a massager that is adapted to easily and securely mount onto a door frame, yet be removable and transportable. Other disadvantages of the prior art will become apparent from the reading of the following specification and claims. Therefore, there remains a long standing and continuing need for an advance in the art of massagers, which shortcomings are addressed by the instant invention.

### SUMMARY OF THE INVENTION

In keeping with the principles of the present invention, a unique massager device is disclosed wherein the device is capable of use by a variety of users having a varying height range.

In addition, by providing a substantially rigid body, the device is durable and cost efficient to manufacture.

Furthermore, because of its compact size, the massager is easily transportable and removably mountable to a door, fence or post at varying adjustable heights.

One aspect of a preferred embodiment of the massager is that it is substantially “U” shaped and it can be mounted directly to a door. An inner surface defined of the “U” shape can frictionally engage an object therein. A protrusion, that has a preferably smooth surface, is attached to the outer surface of a second region of the massager which may also be the elongated region of the “U” shape.

Another aspect of an alternate preferred embodiment is to provide a number of interchangeable protrusions such that the protrusions may be used as deep tissue massagers or, through the use of an alternately shaped protrusion, may be used to scratch the back of a user.

Another aspect of the invention is to provide an attaching member that is adjustable such that objects of varying widths can be maintained between the opposing first region and the second region. Attaching member has a threaded region that is adjustably received in the first region and has an engaging region that forces the object towards an inner surface of second region to maintain the massager in a secure manner to the object.

Such stated summary of preferred embodiments of the invention are only examples and should not be construed as limiting the present invention. These and other features, aspects, and advantages of the invention herein will become more apparent from the following detailed description of the preferred embodiments of the invention when taken in conjunction with the accompanying drawings and the claims that follow.

### BRIEF DESCRIPTION OF THE DRAWINGS

It is to be understood that the drawings are to be used for the purposes of setting forth preferred embodiments of the invention via illustration only and not as a definition of the limits of the invention. In the drawings, wherein similar reference characters denote similar elements throughout the several views:

FIG. 1 is a side elevational view of a massager.

FIG. 2 is a cross-sectional view of the massager taken along line 2-2 of FIG. 1.

### DETAILED DESCRIPTION OF THE INVENTION

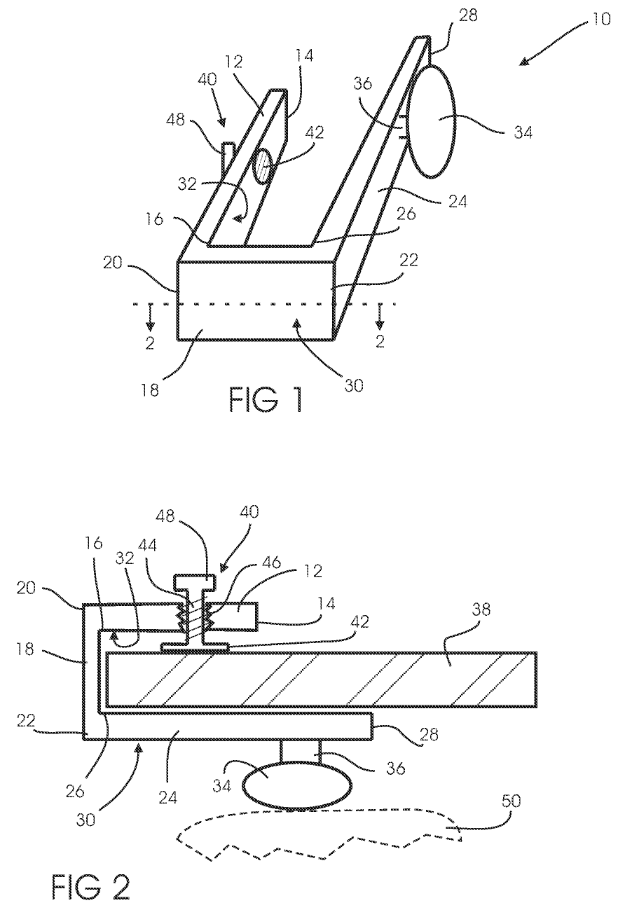

Referring now to the FIG. 1, a preferred embodiment of a removably mountable massager generally designated by reference numeral 10 is illustrated. In one preferred embodiment, massager 10 is made of plastic and is preferably injection molded in one piece, however, it is to be understood that other manufacturing methods known in the art may also be employed. For purposes of illustration, but not limitation, massager 10 may be formed of several separate pieces of plastic that are sonic welded or adhered to one another by either an adhesive substance or a threaded attaching member, such as a screws. Furthermore, massager 10 may be made of metal, wood, fiberglass or any other rigid material that is capable of being removably mounted.

Massager 10 has a first region 12 that is substantially planar. First region 12 has a first end 14 and a second end 16, whereby second end 16 is attached to a left end 20 of middle region 18. A right end 22 is defined on middle region 18 distal to left end 20. A second region 24 has a leading end 26 and a distal trailing end 28, whereby leading end 26 is attached to right end 22. In such arrangement, first region 12 and second region 24 are in a substantially parallel arrangement such that a substantially “U” shaped massager 10 is formed. First 12, second 24 and middle 18 regions have an outer surface 30 and an inner surface 32, the inner surface 32 being defined on the inner portion of the “U” shape.

In one preferred embodiment, a protrusion 34 extends from outer surface 30 of second region 24 in an opposing direction to inner surface 32. Although protrusion 34 is illustrated as an ellipsoid in a preferred embodiment, it is to be understood that protrusion 34 may take alternate preferred spherical or non-symmetrical shapes, such as egg-shapes. Protrusion 34 may be directly connected to outer surface 30 of second region 24 or, in an alternate preferred embodiment, protrusion 34 may be attached to second region 24 via a stem 36.

Protrusion 34 and stem 36 may be injection molded as part of the first 12, middle 18, and second 24 regions and be of one unitary piece. However, in an alternate embodiment, protrusion 34 has a threaded region and protrusion 34 has a threaded portion that mates with the treaded region, such that protrusion 34 may be replaced by varying massaging protrusion 34 shapes as desired by the user.

Now also referring to FIG. 2, inner surface 32 of first 12, middle 18, and second 24 regions may be textured to allow inner surface 32 to frictionally engage an object 38 in a secure yet removable manner. Alternatively, a non-slip material, such as rubber or adhesive, may be applied to inner surface 32 to further enhance the engagement of object 38. Object 38 may be a door panel, a fence post, a backrest of a chair or any other stable item to which massager 10 can attach.

In an alternate preferred embodiment, an attaching member 40 is provided on first region 12 to adjustably mount massager 12 onto object 38 of varying widths. Attaching member 40 has an engaging region 42 that is substantially planar and extends inwardly from inner surface 32 and contacts object 38. A threaded member 44 attaches to engaging region 42 on a side opposite to the side of attachment between engaging region 42 and object 38. Threaded member 44 is received within and travels through an opening 46 defined through first region 12 in a threaded manner to correspond with threaded member 44. A handle 48 is provided on threaded member 44 at an end distal to the engaging region such that the attaching member 40 can be turned until object 38 is maintained in a secure manner between second region 24 and engaging region 42.

While massager 10 is securely fastened to an object 38, a body part 50 of a user can be rubbed on protrusion 34 to achieve a massage. In one preferred embodiment, body part 50 is the lower back of a user. However, because of the adjustable nature of massager 10, it can be secured at varying heights of object 38 to allow manipulation of a different body part 50. For example, if massager 10 is attached at a higher region of object 38, it allows the massage of the upper back of a user.

In one preferred embodiment, first 12, middle 18, and second region 24 have a height of one inch and a thickness of ¼ inch. First region 12 has a length approximately four inches, middle region 18 has a length of approximately three inches, and second region 24 has a length of approximately six inches. Attaching member 40 is situated approximately one inch from first end 14 and stem 36 is situated approximately one inch from trailing end 28. These exact measurements are provided to illustrate one preferred embodiment of the invention and it is to be understood that variations in the size of massager 10 can be instituted that do not vary from the teachings hereof.

While the above description contains many specificities, these should not be construed as limitations on the scope of the invention, but rather as an exemplification the preferred embodiments thereof. Many other variations are possible without departing from the essential spirit of this invention. Accordingly, the scope of the invention should be determined not by the embodiments illustrated, but by the appended claims and their legal equivalents.

What is claimed is:

1. A massager device, comprising:
a first region attached to a middle region and a second region attached to said middle region such that the first region and the second region extend from said middle region in a substantially parallel manner to one another;
an inner surface defined along the first, middle, and second regions on a side where the first and second regions face one another;
an outer surface defined along the first, middle, and second region on the side opposite said inner surface;
a protrusion extending from said second region to allow manipulation of a body part of a user;
an object being frictionally maintained on the inner surface between the first, middle, and second regions in a secure yet removable manner.

2. The device of claim 1, wherein the massager is manufactured from a unitary piece.

3. The device of claim 1, wherein the first, middle and second regions are made of a unitary piece.

4. The device of claim 3, wherein the protrusion is detachable.

5. A massager device, comprising:
a first region attached to a middle region and a second region attached to said middle region such that the first region and the second region extend from said middle region in a substantially parallel manner to one another;
an inner surface defined along the first, middle, and second regions where the first and second regions face one another;
an outer surface defined along the first, middle, and second region on the side opposite said inner surface;
a protrusion extending from the outer surface of said second region to allow manipulation of a body part of a user;
an attaching member extending from said first region to attach the massager to an object in a secure yet removable manner.

6. The device of claim 5, wherein a stem attaches said protrusion to said outer surface of said second region.

7. The device of claim 5, wherein said protrusion has a threaded portion and said second region has a threaded portion such that said protrusion removably mates with said second region.

8. The device of claim 6, wherein said stem extends from said second region in a unitary manner and said stem has a threaded region and said protrusion has a threaded portion such that said protrusion removably mates with said stem.

9. The device of claim 8, wherein a plurality of alternately shaped protrusions can removably mate with said stem in a secure manner.

10. The device of claim 5, wherein a shape of said protrusion is selected from a group consisting of spherical, ellipsoidal, pyramidal or egg-shape.

11. The device of claim 6, wherein said first region, middle region, second region, and stem are formed of a unitary piece.

12. The device of claim 11, wherein said first region, middle region, second region and stem are injection molded.

13. The device of claim 5, wherein an opening defined through said first region receives a threaded member defined on said attaching member in an adjustable manner.

14. The device of claim 13, wherein a handle and engaging region are defined on opposing ends of the threaded member, whereby the manipulation of the handle can direct the engaging region towards or away from the object located between the first and second regions.

15. The device of claim 5, wherein the object is selected from a group consisting of a door, a door-frame, a wall, a fence, a post, and a backrest of a chair.

16. The device of claim 14, wherein the object is selected from a group consisting of a door, a door-frame, a wall, a fence, a post, and a backrest of a chair.

17. The device of claim 5, wherein said first region has a length of four inches, said middle region has a length of three inches, and said second region has a length of six inches.

18. The device of claim 17, wherein said attaching member is located one inch from a first end of said first region that is distal to said middle region and said protrusion is located one inch from a trailing end of said second region that is distal to said middle region.

19. A removable and portable massager device, comprising:
a first region attached to a middle region and a second region attached to said middle region such that the first region and the second region extend from said middle region in a similar direction and are substantially parallel one another;
an inner surface defined along the first, middle, and second regions where the first and second regions face one another;
an outer surface defined along the first, middle, and second region on the side opposite said inner surface;
a stem extending from the outer surface of the second region and removably, yet securely, maintaining a protrusion which manipulates a body part of a user;
an attaching member having a handle region and an engaging region connected via a threaded member;
an opening defined through said first region in a threaded manner that moveably receives the threaded member therein;
whereby, the handle region may be turned to move the engaging region toward or away from an object to either release or engage the object from the inner surface of the second region.

20. The massager device of claim 19, wherein said first region, middle region, second region, and stem are formed of a unitary piece by injection molding.
